(19) United States
(12) Patent Application Publication
(10) Pub. No.: US 2024/0158169 A1
(43) Pub. Date: May 16, 2024

(54) SHUTTLE SYSTEM, AND METHOD FOR OPERATING A SHUTTLE SYSTEM

(71) Applicant: Gebhardt Fördertechnik GmbH, Sinsheim (DE)

(72) Inventors: Marco Gebhardt, Sinsheim (DE); Fabian Branner, Bad Krotzingen (DE); Volker Nicolai, Karlsbad (DE)

(21) Appl. No.: 18/509,566

(22) Filed: Nov. 15, 2023

(30) Foreign Application Priority Data
Nov. 15, 2022 (DE) 10 2022 130 207.5

(51) Int. Cl. B65G 1/04; B65G 1/137

(52) U.S. Cl. CPC B65G 1/0492; B65G 1/1378

(57) ABSTRACT

In a method for operating a shuttle system, at least one shuttle is intended to accept a load carrier, to be put into storage, from a transfer station, and to transfer a load carrier, to be removed from storage, to a transfer station.

### CROSS-REFERENCE TO RELATED APPLICATION

This application claims priority to German Patent Application No. DE102022130207.5, filed on Nov. 15, 2022, the contents of which is hereby incorporated by reference in its entirety.

### TECHNICAL FIELD

The invention relates to a shuttle system and to method for operating a shuttle system.

### BACKGROUND

Shuttle systems are known from the prior art.

However, prior art shuttle systems may involve disadvantages that the present invention addresses or overcomes.

The present disclosure, and embodiments disclosed herein, lead to solutions to one or more problems found in the prior art.

### SUMMARY

A shuttle system according to the present invention comprises a shelf construction having a storage and retrieval plane, and at least one storage plane. The shuttle system preferably comprises a plurality of storage planes and exactly one storage and retrieval plane. However, embodiments having two or more storage and retrieval planes are also conceivable. Preferably storage locations for load carriers are located in the storage and retrieval plane.

The shuttle system further comprises at least one shuttle that moves in the planes of the shelf construction.

The shelf construction comprises a shelf front. The shelf front is preferably a side of the shelf construction, i.e. viewed in outline an edge of the shelf construction. The shelf construction is preferably configured to be substantially rectangular, such that the shelf front constitutes one of the four edges of the rectangular outline of the shelf construction.

The shelf construction comprises at least one vertical conveyor. The shelf construction preferably comprises a plurality of vertical conveyors.

The shelf construction comprises at least two transfer stations, along the shelf front, for storing a load carrier and retrieving it into/from the shelf construction. Preferably, said transfer stations are arranged merely in the storage and retrieval plane. Preferably, retrieval of a load carrier from storage is understood to mean a process in which a load carrier is transferred from its storage location in the shelf construction to a conveyor means outside of the shelf construction. Placing into storage is the reverse process. Typically, both placing into storage and removal from storage comprise a plurality of partial processes. If reference is made for example to the transfer stations serving for placing into and removal from storage, then the transfer station thus does not have to perform the entire process of placing into and removal from storage, but rather merely be involved in a partial process. Preferably, industrial trucks, in particular automatic guided vehicles (AGV), are used as conveying means outside of the shelf construction, which trucks transfer load carriers to the transfer stations and accept them from these. This is described in more detail below. In this case, the term “AGV” also includes what are known as “autonomous mobile robots (AMR)” which are sometimes also referred to as “autonomous AGVs”.

The vertical conveyor is assigned at least two transfer stations. The shelf construction comprises a plurality of vertical conveyors, and thus each vertical conveyor can be assigned at least two transfer stations. For example for structural reasons, for example when a vertical conveyor is arranged close to the shelf support, it may be the case, on account of the space requirement of the shelf support or for other reasons, that individual vertical conveyors are assigned just one transfer station. If a plurality of vertical conveyors is provided, then nonetheless preferably one vertical conveyor, more preferably a portion of said vertical conveyors, particularly preferably a plurality of said vertical conveyors, is assigned at least two transfer stations.

Such a transfer station that is “assigned” to the vertical conveyor is located at least in the spatial vicinity of the vertical conveyor. It does not necessarily have to directly adjoin the vertical conveyor. Preferably the transfer stations assigned to a particular vertical conveyor are arranged closer to the relevant vertical conveyor than to the other vertical conveyors of the shuttle system. For at least some of the transfer stations, this assignment, which will be described in greater detail in the following, may, however, vary as needed. The assignment is thus not fixed invariably in each embodiment. Preferably, however, at least two transfer stations are assigned to each vertical conveyor in such a way that they serve only, or in any case preferably, for handling load carriers which were previously conveyed by said vertical conveyor or will subsequently be conveyed by said vertical conveyor.

The transfer stations are configured to allow a transfer of a load carrier from a shuttle travelling in the storage and retrieval plane or from a transverse travel trolley travelling in parallel with the shelf front in the storage and retrieval plane to an industrial truck travelling along the shelf front, and vice versa. The transfer stations are preferably located directly at or in the shelf front. The shuttle system can comprise such industrial trucks, in particular AGVs. However, it may also be conceivable for the load carrier to be accepted from or transferred to a transfer station, configured as described above, in a manner other than by an industrial truck.

At least two transfer locations are assigned to the at least one vertical conveyor.

Within the context of the present invention, the transfer stations and the transfer locations can be configured at least similarly, in particular can comprise deposition rails for depositing a load carrier, but otherwise do not comprise any conveying means or similar active elements. Within the context of the present invention, transfer stations are preferably the transfer points as described above, arranged on or in the shelf front, which transfer points allow the transfer of a load carrier from an industrial truck travelling outside of the shelf construction to a shuttle travelling in the shelf construction or to a transverse travel trolley travelling there, and vice versa. In contrast, transfer locations are preferably transfer points which directly adjoin the vertical conveyor and allow the transfer of a load carrier from the vertical conveyor to a shuttle travelling in the shelf construction, and vice versa.

If a plurality of vertical conveyors is provided, then preferably each vertical conveyor is assigned at least two transfer locations. As already mentioned, each vertical conveyor is preferably assigned exactly two transfer locations, which are arranged beside the vertical conveyor in such a way ha they directly adjoin it. Preferably, the transfer locations are configured such that a load handling device of the vertical conveyor, for example a telescopic fork or the like, can deposit a load carrier on the transfer locations or receive it therefrom. Preferably, the transfer stations are further from the vertical conveyor than the transfer locations are.

The transfer locations are configured to allow a transfer of a load carrier from the vertical conveyor to a shuttle travelling in the storage and retrieval plane, and vice versa, or to the transverse travel trolley, and vice versa.

At least two transfer stations can be assigned to the at least one vertical conveyor in such a way that in each case at least one transfer station is located before and after the vertical conveyor, along the shelf front. If a plurality of vertical conveyors is present, then this preferably applies for all the vertical conveyors. In this case, the spatial statement “before or after the vertical conveyor” preferably relates to a longitudinal direction of the shelf front. Preferably, at least some of the vertical conveyors, more preferably each vertical conveyor, are assigned more than two transfer stations, for example four, five or six transfer stations.

At least two transfer locations can be assigned to the at least one vertical conveyor in such a way that in each case at least one transfer location is located before and after the vertical conveyor, along the shelf front. If a plurality of vertical conveyors is present, then this preferably applies for all the vertical conveyors. In this case, the spatial statement “before or after the vertical conveyor” preferably relates to a longitudinal direction of the shelf front. Preferably each vertical conveyor is assigned exactly two transfer locations, wherein one transfer location is located in front of the vertical conveyor and one transfer location is located after the vertical conveyor, as already described above.

The above-described arrangement of transfer stations and transfer locations can ensure that, even in the case of two shuttles being assigned to the vertical conveyor, the travel paths of which shuttles do not or in any case rarely cross, which would result in braking of a shuttle and thus slowing of the load carrier transfer. Based on the longitudinal direction of the shelf front, in the case described above a shuttle responsible for storing into storage can travel preferably or exclusively in front of the vertical conveyor, between the transfer stations and transfer locations located in front of the vertical conveyor, while a shuttle responsible for retrieval travels preferably or exclusively after the vertical conveyor, between the transfer stations and transfer locations located after the vertical conveyor.

At least one shuttle can be assigned to the vertical conveyor, which shuttle is configured to transport load carriers from the transfer stations to the transfer locations and back. In this case, “be assigned to” preferably means that at least one, preferably exactly one or exactly two, shuttles are provided, which are largely or exclusively used to transport load carriers from the transfer stations to the transfer locations and back. In alternative variants it can be conceivable for other shuttles, which travel in the storage and retrieval plane, to transport the load carriers from the transfer stations to the transfer locations and back, wherein said shuttles also undertake other assignments in the storage and retrieval plane. Preferably, however, one or two shuttles largely or exclusively responsible for this assignment are provided for the transport of load carriers between the transfer locations and transfer stations.

The optionally provided transverse travel trolley can replace the shuttles which are assigned to the vertical conveyors. Furthermore, the transverse travel trolleys are compatible with all the embodiments and details of the present invention set out below.

Preferably, the transfer stations are arranged along the shelf front. The optional transverse travel trolleys can be arranged displaceably on a rail which extends in parallel with the shelf front and thus in parallel with the transfer stations.

One or more transverse travel trolleys can be arranged on said rail.

The transverse travel trolleys can be equipped with a load handling device such as a telescopic fork, which makes it possible to deposit a load carrier on one of the transfer stations or to receive it therefrom. Preferably, for this purpose the telescopic fork is movable orthogonally to the longitudinal direction of the rail of the transverse travel trolley. Furthermore, the telescopic fork can make it possible to transfer a load carrier to the vertical conveyor. Said transfer can take place directly, in that the transverse travel trolley deposits the load carrier directly on the vertical conveyor, for example on its telescopic fork, or indirectly, in that the transverse travel trolley deposits the load carrier on a transfer location assigned to the vertical conveyor.

It may also be conceivable for the transverse travel trolley to transfer load carriers, which were deposited on the transfer stations and are intended to be put into storage in the storage and retrieval plane, to the shuttles travelling there. During retrieval from the storage and retrieval plane the reverse applies.

Alternatively, or in addition to the above-described load handling device, for example the telescopic fork, the transverse travel trolley can comprise a conveying means such as a chain conveyor, a belt conveyor or a roller conveyor. In this case, some or all of the transfer stations and/or transfer locations can also be equipped with chain conveyors, belt conveyors, roller conveyors or the like. Finally, for example a passive transfer station without conveying means cannot deposit a load carrier, deposited thereon, on a transverse travel trolley equipped exclusively with a chain conveyor, and the latter cannot accept the load carrier from a passive transfer station without additional conveying means.

The rail of the transverse travel trolley(s) can extend between the vertical conveyor in the shelf construction and the transfer stations.

It may be conceivable for a transfer of load carriers between the transfer stations and the vertical conveyors, and also the shuttles travelling in the storage and retrieval plane, to take place exclusively via the transverse travel trolleys, if at least one such transverse travel trolley is present.

Alternatively, it may be conceivable for the rail of the transverse travel trolley(s) to be configured and arranged in such a way that the shuttle can pass the first-mentioned shuttle, travelling on its travel rails, in order to reach the transfer stations and for example collect a load carrier, to be put into storage in the storage and retrieval plane, from the transfer stations. In this alternative example, the transverse travel trolleys exclusively or at least mainly serve the vertical conveyor.

The at least two transfer stations advantageously decouple the actions for example of the industrial truck, in particular of the AGV, and the shuttle(s) travelling in the shelf construction or the transverse travel trolley. The above-mentioned conveying means for transferring a load carrier therefore do not have to be at the same site at the same time.

Preferably, in each case both a transfer location and a transfer station are arranged in front of the vertical conveyor, and in each case a transfer location and a transfer station are arranged after the vertical conveyor. By means of such an arrangement, double runs can be performed, during storing into and retrieving from storage, without risk of blocking. The vertical conveyor can perform double runs. If the vertical conveyor leaves the storage and retrieval plane in the direction of the storage plane, then it can always transport a load carrier that is to be put into storage, and in the subsequent return journey into the storage and retrieval plane it can always transport a load carrier that is to be removed from storage. If exactly two transfer locations are provided, wherein the vertical conveyor accepts the load carrier to be put into storage from a first transfer location, and deposits the load carrier to be removed from storage at the second transfer location, then no blockages occur in the direct vicinity of the vertical conveyor and in the context of accepting and transferring load carriers from and to the vertical conveyor, because processes for storing into storage and retrieving from storage are spatially separated. If the vertical conveyor is furthermore assigned exactly two shuttles, wherein a first shuttle largely or exclusively transports load carriers to be put into storage, from the first transfer station to the first transfer location, and wherein a second shuttle largely or exclusively transports load carriers to be removed from storage, from the second transfer location to the second transfer station, then any blocking effects are further prevented. Finally, it is not possible, for example, for the two above-mentioned shuttles to “be in each other's way”. This is also brought about by the design described above, since, with respect to the longitudinal direction, the at least one first transfer station and the first transfer location on the one hand and the at least one second transfer station and the second transfer location on the other hand, are in each case located on different sides of the vertical conveyor, with respect to the vertical conveyor and with respect to the longitudinal direction of the shelf front. The shuttle travelling between the first transfer location and one of the first transfer stations therefore does not cross the travel path of a shuttle travelling between the second transfer location and one of the second transfer stations.

In the storage and retrieval plane, in addition to the above-described at least one shuttle which largely or exclusively transports load carriers between the transfer locations and the transfer stations, further shuttles can also be provided. These preferably largely or exclusively transport load carriers from the transfer stations to storage locations in the storage and retrieval plane.

Within the context of the present invention, preferably the transfer station that is approached first by the industrial truck moving in its travel direction and substantially along the shelf front, and on which the load carrier is deposited, is referred to as the “first transfer station”. Typically, the second transfer stations are identical in design, but the industrial truck receives a pallet there for example. Analogous considerations apply for example for the first and second transfer locations, which generally directly adjoin the vertical conveyor.

Particularly preferably, the first transfer station is defined in that an industrial truck or the like deposits thereon a load carrier to be put into storage, while a second transfer station is preferably defined in that a shuttle deposits thereon a load carrier to be removed from storage, which can then be accepted by an industrial truck or the like.

In addition to the shuttle system described above, the present invention also relates to a method described below for operating a shuttle system of this kind. Features and details which are described in the following with reference to the method can also be used in the above-described shuttle system, and vice versa.

In a method for operating a shuttle system, which can be configured as described above, it is provided that the at least one shuttle or a transverse travel trolley accepts a load carrier, to be put into storage, from a transfer station, and/or transfers a load carrier, to be removed from storage, to a transfer station.

In this case, exactly two shuttles can be provided, wherein a first shuttle exclusively accepts load carriers to be put into storage, from one of the first transfer stations, and deposits them on a first transfer location, and wherein a second shuttle exclusively accepts load carriers to be removed from storage, from the second transfer location, and deposits them on one of the second transfer stations. In this case, it may be conceivable to assign each vertical conveyor the exactly two shuttles described above.

It is thus preferably the case, in any event for all embodiments without transverse travel trolleys, that the transfer stations are served on the storage side, exclusively by the shuttles which travel in the storage and retrieval plane. Further preferably, particular shuttles are provided for this purpose which largely or exclusively transport load carriers between the transfer stations and the transfer locations, and for example do not undertake the storing of load carriers into the storage locations of the storage and retrieval plane.

Although the shuttles can move horizontally, they cannot change planes, i.e. for example cannot change from the storage and retrieval plane into one of the storage planes. In some embodiments, however, it may be conceivable to use a vertical conveyor for the shuttles, which shuttles can transport between the planes of the shelf construction, i.e. for example from the storage and retrieval plane into one of the storage planes. In such a case, a shuttle previously travelling in the storage plane, after it has been transported into the storage and retrieval plane, can also bring about the transport of load carriers between the transfer locations and the transfer stations.

If a transverse travel trolley is provided, then exactly one transverse travel trolley can be provided, which handles load carriers to be put into storage and to be removed from storage. Alternatively, it may be conceivable to use a plurality of transverse travel trolleys. Furthermore, it may be conceivable for each vertical conveyor to be assigned exactly two transverse travel trolleys. If at least one transverse travel trolley is provided, then this is preferably provided exclusively in the storage and retrieval plane, while the storage planes preferably do not comprise any transverse travel trolleys.

The load carriers can be pallets. However, other load carriers, in particular large load carriers, are also conceivable.

The transfer stations and the transfer locations can comprise two parallel deposition rails, on which a pallet can be deposited.

Preferably, the transfer stations and the transfer locations are single-depth, i.e. each transfer station only offers space for exactly one pallet.

These are preferably transfer stations and transfer locations, which for example do not comprise any conveying means for moving the load carriers.

The method can comprise storing and/or retrieving of at least one load carrier from a storage plane or into a storage plane, having the following steps:
for storing a load carrier in a storage plane, the load carrier is deposited on a first transfer station and subsequently transported by a shuttle or a transverse travel trolley to a first transfer location assigned to the vertical conveyor, whereupon the vertical conveyor accepts the load carrier and conveys it into the storage plane,
for retrieving a load carrier stored in a storage plane, the load carrier is transferred from a shuttle travelling in the storage plane to the vertical conveyor, whereupon the vertical conveyor conveys the load carrier into the storage and retrieval plane and deposits it on a second transfer location, where a shuttle or a transverse travel trolley accepts the load carrier and transports it to a second transfer station.

The above acceptance of the load carrier by the vertical conveyor can take place for example by its telescopic fork. Corresponding applies for the deposition of the load carrier onto the second transfer location, during retrieval.

Alternatively, the method can comprise storing and/or retrieving of at least one load carrier from a storage plane or into a storage plane, having the following steps:
for storing a load carrier in a storage and retrieval plane, the load carrier is deposited on a first transfer station and subsequently received by a transverse travel trolley and transferred to a shuttle, which transports the load carrier to a storage location,
for retrieving a load carrier that is stored in the storage and retrieval plane, said load carrier is accepted, at its storage location, by a shuttle and transferred to the transverse travel trolley, which transports the load carrier to the second transfer station.

The method can comprise either only the above-described storing or only the above-described retrieving or both processes. For example, it may be conceivable that the method comprises only the above-described retrieval when an industrial truck travels empty, i.e. not laden with a load carrier, into the storage pre-zone, or in general approaches the shelf front. In such a case, the industrial truck is intended to exclusively receive a load carrier from a transfer station and transport it to a target location.

During storing, the load carrier is preferably deposited, by an AGV or another industrial truck, on the first transfer station. Subsequently, the load carrier is preferably transported from the first shuttle, already described, to the first transfer location assigned to the vertical conveyor. Preferably, the vertical conveyor actively accepts the load carrier, using a load handling device provided for this purpose, such as a telescopic fork.

During retrieval, a shuttle travelling in the storage plane can receive a load carrier that is put into storage there on a storage location, and can transfer this to the vertical conveyor. In all the storage planes, one or more shuttles can travel. In each storage plane, transfer locations, preferably exactly two transfer locations, can be provided beside the vertical conveyor. The transfer of the load carrier from the shuttle in the storage plane to the vertical conveyor can consist in the vertical conveyor receiving the load carrier using a suitable load handling device, after the shuttle has deposited it on a transfer location in the storage plane.

The transfer locations in the storage planes can be configured as has already been described above with respect to the transfer locations in the storage and retrieval plane.

It may be conceivable that the vertical conveyor deposits the load carrier to be put into storage on a transfer location in a storage plane, and receives a load carrier to be removed from storage from another transfer location in the same storage plane and transports it into the storage and retrieval plane.

Alternatively, it may be conceivable that the vertical conveyor, after storing a load carrier, receives a load carrier to be removed from storage, from another storage plane, and transports said load carrier into the storage and retrieval plane. For example, the vertical conveyor, following transfer of a load carrier to be put into storage on a storage plane located high up in the shelf construction, can travel downwards, in this case stop at the height between the above-mentioned storage plane and the storage and retrieval plane, and receive a load carrier that is provided there and is to be removed from storage. In this manner, single runs are also prevented, and the efficiency of the method is also increased, when there is currently no load carrier to be removed from storage ready in the storage plane in which a load carrier is put into storage.

Preferably, the storage and retrieval plane also comprises storage locations. Load carriers can be put into and removed from storage in this place without using the vertical conveyor. If the method comprises storing and/or retrieving of at least one load carrier, from the storage and retrieval plane or into the storage and retrieval plane, the following steps can be performed:
for storing a load carrier in a storage and retrieval plane, the load carrier is deposited on a first transfer station and subsequently transported by a shuttle to a storage location,
for retrieving, a load carrier that is stored in the storage and retrieval plane, said load carrier is accepted, at its storage location, by a shuttle and transported to a second transfer station.

Alternatively, a method can comprise storing and/or retrieving at least one load carrier, from the storage and retrieval plane or into the storage and retrieval plane, in which the following steps are performed:
for storing a load carrier, in a storage and retrieval plane, the load carrier is deposited on a first transfer station and subsequently received by a transverse travel trolley and transferred to a shuttle, which transports the load carrier to a storage location,
for retrieving, a load carrier that is stored in the storage and retrieval plane, said load carrier is accepted, at its storage location, by a shuttle and transferred to the transverse travel trolley, which transports the load carrier to the second transfer station.

Preferably, the load carrier to be put into storage is deposited, for storing, by an AGV on the transfer station. For retrieving, the load carrier to be removed from storage is preferably accepted by the same or a different AGV.

If the method comprises storing and/or retrieving of at least one load carrier from one of the storage planes or into one of the storage planes, then the following steps can be performed:
for storing the load carrier in the storage plane, the load carrier is deposited by an industrial truck, for example an AGV, onto the first transfer station, and subsequently transported by a first shuttle to a first transfer location assigned to the vertical conveyor, whereupon the vertical conveyor accepts the load carrier and conveys it into the storage plane,
for retrieving the load carrier stored in a storage plane, said load carrier is transferred from the shuttle travelling in the storage plane to the vertical conveyor, whereupon the vertical conveyor conveys the load carrier into the storage and retrieval plane and deposits it on the second transfer location, where the first or a second shuttle accepts the load carrier and transports it to the second transfer station,
wherein the industrial truck or another industrial truck accepts the load carrier deposited on the second transfer station,
wherein a travel direction of the industrial truck extends along the shelf front, and
wherein, as the second transfer station, a transfer station is selected which is located downstream of the first transfer station with respect to the travel direction.

It may be conceivable that the industrial truck firstly deposits the load carrier on the first transfer station, and then accepts a load carrier to be removed from storage, which was transported by the same vertical conveyor into the storage and retrieval plane, and thus is provided on a second transfer location which is assigned to said vertical conveyor.

The vertical conveyor can convey said load carrier, to be removed from storage, into the storage and retrieval plane, before or after it has conveyed the load carrier, to be put into storage, into the storage plane.

It may also be conceivable that the industrial truck firstly deposits the load carrier on the first transfer station, which is assigned to the vertical conveyor, and then accepts a load carrier to be removed from storage, which was transported by another vertical conveyor into the storage and retrieval plane, and is provided on a second transfer station which is assigned to said other vertical conveyor.

The second transfer station approached by the industrial truck, from which station said industrial truck accepts a load carrier, can thus be assigned to a different vertical conveyor compared with the first transfer station on which the industrial truck has previously deposited the load carrier to be put into storage. However, the other vertical conveyor is preferably located downstream of the first-mentioned vertical conveyor, such that the industrial truck does not have to change its travel direction along the shelf front. If a plurality of industrial trucks, reaching the shelf construction in short time intervals, perform the above-mentioned steps, then a situation with oncoming traffic is prevented by the selection of the above-mentioned travel direction.

This preferably applies for all he embodiments of the present invention: The industrial trucks travel substantially along, and thus in parallel with, the shelf front, wherein they can also travel substantially orthogonally to the shelf front, in portions, for example for the purpose of depositing and receiving a load carrier. However, the travel along and in parallel with the shelf front takes place prior to entry into the storage pre-zone, and preferably always just in one direction, until leaving the storage pre-zone.

If the first and the second transfer station, which are approached by the industrial truck for the purpose of depositing and receiving a load carrier, are assigned to the same vertical conveyor, then the second transfer station is preferably located along the travel direction of the industrial truck, which in turn extends along the shelf front, behind the previously approached first transfer station.

As has already been indicated above, the same preferably also applies for the case in which the second transfer station is assigned to a different vertical conveyor from the first transfer station. This ensures that the industrial truck preferably always travels in just one direction along the shelf front. Direction changes, i.e. backward travel, as it were, could lead to blocking effects, if a plurality of industrial trucks travel along the shelf front.

Preferably, a plurality of industrial trucks travel along the shelf front, and preferably all these industrial trucks travel along the same preferred direction extending in parallel with and along the shelf front. This applies either for the entire shelf front or for a plurality of portions into which the shelf front can be divided with respect to the travel directions of the industrial trucks. In a considered portion along the shelf front, preferably all the industrial trucks travelling there travel in the same direction.

In the method described above, comprising storing and/or retrieving of at least one load carrier from one of the storage planes, it may be conceivable that any shuttle, travelling within the storage and retrieval plane, may undertake the transport of the load carriers between the transfer locations and the transfer stations. Alternatively, specific shuttles or a specific shuttle may also be provided for this purpose. Particularly preferably, it may be conceivable to provide exactly one specific shuttle or exactly two specific shuttles. In the case of two specific shuttles, preferably a first shuttle is provided for oscillating between the first transfer location and the first transfer station, and a second shuttle is correspondingly provided for oscillating between the second transfer location and the second transfer station. If a plurality of transfer stations is provided, then the shuttles each oscillate between one of the transfer stations and the correspondingly associated transfer location. The specific shuttles described above, preferably exactly one or exactly two specific shuttles, can in each case be assigned to one vertical conveyor.

As already indicated above, embodiments of the method may be conceivable in which a preferred direction prevails along the shelf front in such a way that industrial trucks travelling along the shelf front move only in one direction, substantially at each point along the shelf front. As a result, oncoming traffic can be largely or completely prevented, which increases the throughput.

It may be conceivable that a majority of the industrial trucks or all the industrial trucks follow the preferred direction. Furthermore, it may be conceivable that the industrial trucks follow the preferred direction in a majority of journeys or always.

Depending on the number of industrial trucks travelling along the shelf front, the preferred direction can be implemented as a single-lane or two-lane one-way path along the shelf front.

There is typically at least one point or one portion on the shelf front which the industrial trucks travel towards before they travel along the shelf front to the corresponding transfer stations. If said point or portion is located at the start or at the end of the shelf front, i.e. for example at a corner of a shelf construction that is rectangular in outline, then preferably a single preferred direction prevails along the shelf front, along the entire shelf front. However, if said point or portion is not arranged at the end, but rather for example centrally, with respect to an overall length of the shelf front, then it may be conceivable that the industrial trucks can travel along the shelf front in two directions, proceeding from said point or portion. From said point or portion, one-way paths can be present in both directions.

Alternatively, it may also be conceivable that each industrial truck for example first approaches the transfer station on the shelf front at which it is intended to receive a load carrier. Subsequently, travel along on the shelf front as described above can take place, wherein a preferred direction, for example one-way traffic, can also prevail. In contrast to the variant described above, however, exactly as many points are provided, for travelling towards the shelf front prior to the travel along the shelf front, as there are transfer stations. There are at least as many such points as there are second transfer stations.

In the light of the above-described details and variants of the method, according to one specific embodiment this may be configured as follows:

An AGV laden with a load carrier enters the storage pre-zone and thereafter travels to a point or portion of the shelf front, and from there along the shelf front to a first transfer station where it deposits the load carrier. A first shuttle, which oscillates back and forth, in the storage and retrieval plane, between the first transfer locations and the first transfer station of a vertical conveyor, accepts the load carrier at the first transfer station and conveys it to the vertical conveyor, which conveys the load carrier into a storage plane. The above-mentioned shuttle can be assigned to the above-mentioned vertical conveyor. The assignment of said shuttle can also be undertaken by a transverse travel trolley.

Meanwhile, the AGV travels further along the shelf front in the preferred direction to a second transfer station, wherein either one of the second transfer stations of the same vertical conveyor is approached, or a second transfer station of a vertical conveyor further away in the preferred direction. There, the AGV receives a load carrier deposited on said second transfer station and conveys it to its target location, for example to a production facility or to an order-picking device. On the return path from the storage plane into the storage and retrieval plane, the first-mentioned vertical conveyor conveys a load carrier to be removed from storage, from the same or another storage plane into the storage and retrieval plane. The vertical conveyor thus operates in double-run operation. If the AGV travels towards a second transfer station of a vertical conveyor that is located further back in the preferred direction, i.e. downstream, then the load carrier to be removed from storage, which the first-mentioned vertical conveyor has conveyed from the storage plane into the storage and retrieval plane, during its return journey, is accepted by another, second AGV, which in particular follows the first-mentioned AGV. Apart from the point or portion of the shelf front at which the AGVs reach the shelf construction, coming from the storage pre-zone, preferably a single preferred direction prevails at each point along the shelf front, such that all AGVs passing these points travel along the shelf front in the same direction.

It may be conceivable to provide a central contour control in such a way that all the industrial trucks can pass the same device for contour control. It may also be conceivable to provide a plurality of devices for contour control, such that industrial trucks which travel towards the shelf construction from different directions do not have to make detours in order to reach the device for contour control. In all cases, it is preferably conceivable for one or more such devices to be used by a plurality of industrial trucks in each case. Following passing the at least one central contour channel, the industrial trucks can start their travel along the shelf front to the transfer stations at a point or portion of the shelf front. The central contour control can be arranged on an edge or a boundary of the storage pre-zone.

It may be conceivable that some of the vertical conveyors or each vertical conveyor are assigned at least three transfer stations. It is possible to determine, for at least one of the transfer stations, depending on an assignment load, whether said transfer station is used for storing or for retrieving of load carriers. It may also be conceivable that it is determined, for all the transfer stations of the vertical conveyor, depending on the assignment load, whether said transfer stations are used for storing or for retrieving of load carriers. Similar can alternatively or additionally apply for the transfer locations.

It may be conceivable for a sequence formation for at least two load carriers to take place in such a way that the industrial trucks, which accept the load carriers from the second transfer stations, form the sequence. If at least two load carriers are brought into a particular sequence, for example for a route-optimized loading on a vehicle, order-picking, a production process, or the like, and in particular are delivered by the industrial truck in a particular sequence, then it is advantageous for this sequence to be formed by the industrial trucks. This increases the flexibility in the store, i.e. in the shelf construction, because the load carriers required for forming a sequence can be provided on the transfer stations in any desired sequence along the shelf front. As long as the load carriers required for the sequence formation are provided within a time period in which the industrial trucks receiving them travel along the shelf front, then there is flexibility in the handling of said load carriers, both temporally and spatially. The temporal sequence in which the above-mentioned load carriers are deposited on the second transfer stations, and on which second transfer stations they are deposited, is then irrelevant. The load carrier required first can be collected by the first available industrial truck, the load carrier required second can be collected from the next available industrial truck, etc. In this case, it is advantageous for a plurality of second transfer stations to be provided, such that there are always sufficient free second transfer stations available, even in the case of parallel processing of two order-picking assignments for example. It is often sufficient to assign each vertical conveyor two or three second transfer stations for this purpose, but there can also be more.

The sequence formation is thus largely outsourced, i.e. largely does not take place in the shelf construction. In this respect, only a part of the sequence formation takes place in the shelf construction, when the load carriers required for a sequence formation are deposited on the second transfer stations substantially within the specified time period, in order that the actual sequence formation can be performed by the AGVs. The sufficient number of existing second transfer stations, on which the load carriers required for the sequence can be deposited, in conjunction with the above-described sequence formation that takes place late and only in part in the material flow in the shelf construction, allows for flexibility and efficiency of all the methods irrespective of the final sequence formation, since the latter takes place outside of the shelf construction, by means of the AGVs.

If a plurality of first and/or a plurality of second transfer stations are used, then it may be conceivable that the shuttle, preferably the first shuttle, or the transverse travel trolley, for storing, transports the load carrier, of a plurality of load carriers provided on a plurality of first transfer stations, to the vertical conveyor which has the shortest travel path or the shortest distance from the vertical conveyor or from the first transfer location. Alternatively, or in addition, it may be conceivable that the shuttle, preferably the second shuttle, or the transverse travel trolley, for retrieving, deposits a load carrier, to be removed from storage, on the second transfer station which has the shortest travel path or the shortest distance from the vertical conveyor or from the second transfer location, from a group of a plurality of second transfer stations. The above-described group of a plurality of second transfer stations is typically selected in such a way that said second transfer stations are currently not occupied. As outlined above, the shuttle(s), which travel between the transfer locations and the transfer stations, can thus be operated in a runtime-optimized manner In a manner dependent on throughput, it may be the case, in such a method, that a load carrier which was deposited on a transfer station that is a very long way from the vertical conveyor, remains there too long. In order to prevent this, it may be conceivable to make the runtime-optimized operation, and in particular the transport of a load carrier having a short travel path between the first transfer station and the first transfer location dependent on whether a load carrier located further away has already been at a first transfer station for longer than a predetermined time period and is waiting for collection and transport to the first transfer location. Vice versa, as already described above, preferably the closest free second transfer station, i.e. that which is not occupied by a load carrier, is selected, which is assigned to the relevant vertical conveyor.

The following aspects may be conceivable in the embodiments of the present invention:

A storage pre-zone can be assigned to the shelf construction, but said zone is not essential. The industrial trucks can also arrive at the shelf front in another manner compared with via a storage pre-zone.

The shelf construction can be configured as a rack store, preferably as a pallet channel store. The shuttles may be pallet shuttles, which are configured to transport pallets, as well as to put them into and remove them from storage. For this purpose, the shuttles can comprise a load handling device, in particular a lifting device.

In the shelf construction, travel rails for the shuttles, and parallel deposition rails preferably extending directly above the travel rail, can extend, which rails are arranged in a grid. Said rails can form both alleys and other travel paths. Preferably, the travel paths extend in parallel with and/or orthogonally to one another. After raising of the load carrier, in particular the pallet, using the load handling device, the shuttle can transport load carriers, travelling on the travel rails, in the shelf. By lowering the load handling device, the load carrier is deposited on the deposition rails. Both the storage channels and the transfer stations and transfer locations can comprise, as an essential component, a portion having two travel rails extending in parallel, and two deposition rails extending above and in parallel.

The above-mentioned grid preferably consists of travel and deposition rails extending orthogonally to and in parallel with one another. For example, a plurality of travel rails can extend in parallel with one another and can be interconnected by travel rails extending orthogonally thereto. The deposition rails, which are oriented in parallel with the travel rail located therebelow in each case, extend above the above-mentioned travel rails.

The shuttles are preferably configured as bidirectional shuttles which can change their travel direction about 90°, for example by means of two chasses or two sets comprising a plurality of wheels or the like, of which at least one is extendable and retractable, or lowerable.

Preferably, at least some of the vertical conveyors, more preferably each vertical conveyor, are assigned two or more transfer stations and exactly two transfer locations.

Preferably, the transfer stations are always arranged in such a way that they form an interface between the shelf construction and a portion outside of the shelf construction located directly in front of the shelf front. An arrangement of transfer stations, in particular relative to a surface on which the industrial trucks travel, is selected in such a way that the industrial trucks, which are typically equipped with load handling devices such as a lifting device, can enter the transfer station and deposit and receive load carriers there using the load handling device.

The vertical conveyors preferably interconnect all the planes of the shelf construction. It may also be conceivable that a vertical conveyor merely connects the storage and retrieval plane with some of the storage planes.

Furthermore, the shelf construction can be configured in a manner as is known from pallet channel stores, which are operated using shuttles. Storage channels, in which the storage locations are arranged, can be single-depth or multiple-depth.

If, in the context of the present invention, reference is made to a first transfer location or a first transfer station, then these are preferably used during storing. Correspondingly, a second transfer station and a second transfer location are used during retrieving. The same applies for a first and a second shuttle travelling within the storage and retrieval plane, but not for a first and a second industrial truck.

The shuttle system can comprise a material flow calculator, or can be operatively connected to such a material flow calculator. The material flow calculator can manage resources and allocate assignments to the shuttles, vertical conveyors and industrial trucks. The material flow calculator can also be connected to a device for contour control.

Although the outline of the shelf construction is preferably substantially rectangular, it can deviate from an ideal rectangle without suffering losses of functionality. In this case, smaller deviations from an ideal rectangle can generally be implemented without problem; a sawtooth-like arrangement of the transfer stations at the boundary between the storage and retrieval plane and the storage pre-zone is also conceivable.

### BRIEF DESCRIPTION OF THE DRAWINGS

FIGS. 1 to 6 each generally illustrate a plan view of a portion of an embodiment of a storage and retrieval plane of a shuttle system.

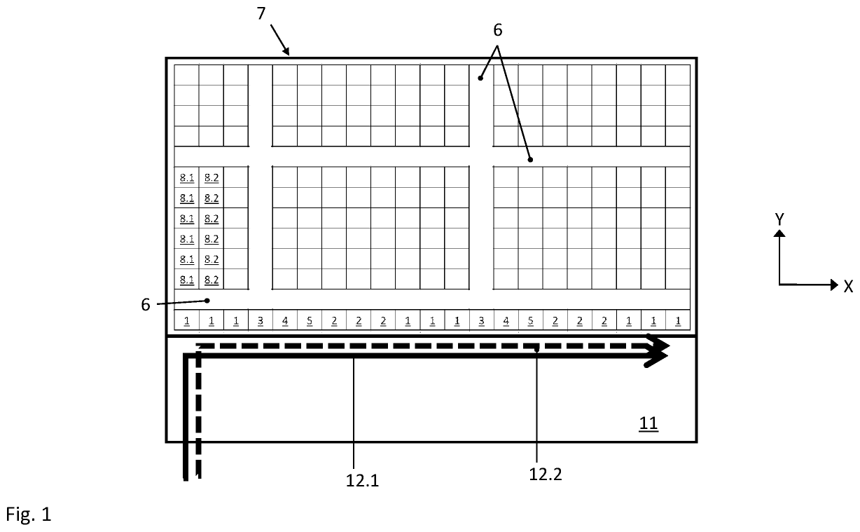

Further advantages, features and details of the invention follow from the following description of embodiments, and on the basis of the drawings which show, in FIGS. 1 to 6, various embodiments of a shuttle system according to the invention.

### DETAILED DESCRIPTION

FIGS. 1 to 6 illustrate a part of a storage and retrieval plane 7 of a shuttle system comprising the upstream storage pre-zone 11. The x- and y-directions are indicated in each case. In this case, travel paths 6 are visible in the storage and retrieval plane 7, which paths extend in the x- and y-direction. The travel paths 6 extending in the x-direction can be referred to as alleys, and the travel paths 6 extending in the y-direction can be referred to as connection paths between the alleys.

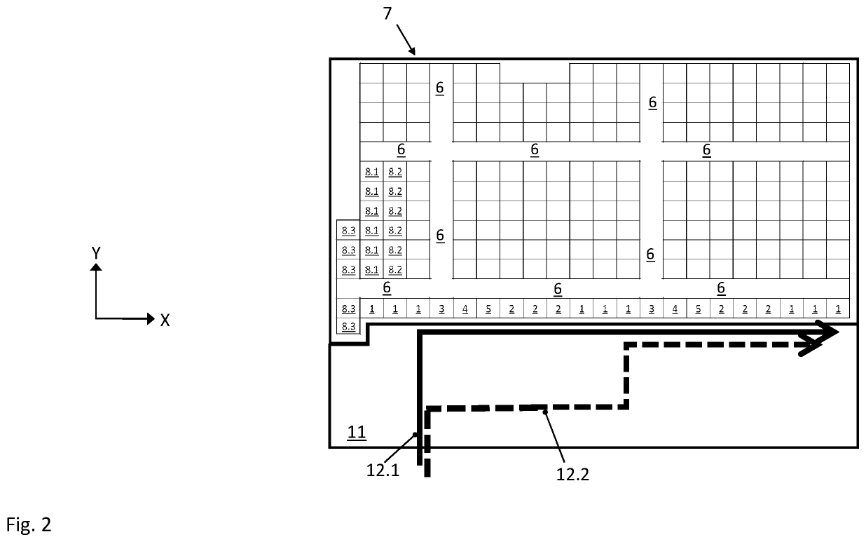

Furthermore, a plurality of first and second transfer stations 1, 2, a plurality of first and second transfer locations 3, 5, and a plurality of vertical conveyors 4 are visible. A plurality of storage locations 8.1 lying one behind the other in the y-direction together form a storage channel extending in the y-direction. The same applies for the storage locations 8.2 and the storage locations 8.3 in FIG. 2. The remaining storage locations and storage channels are not provided separately with reference signs, for the sake of clarity.

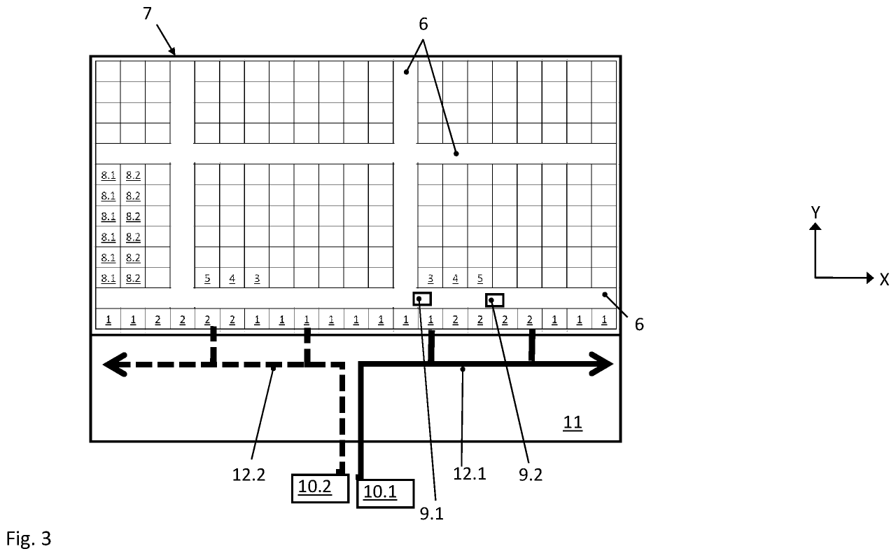

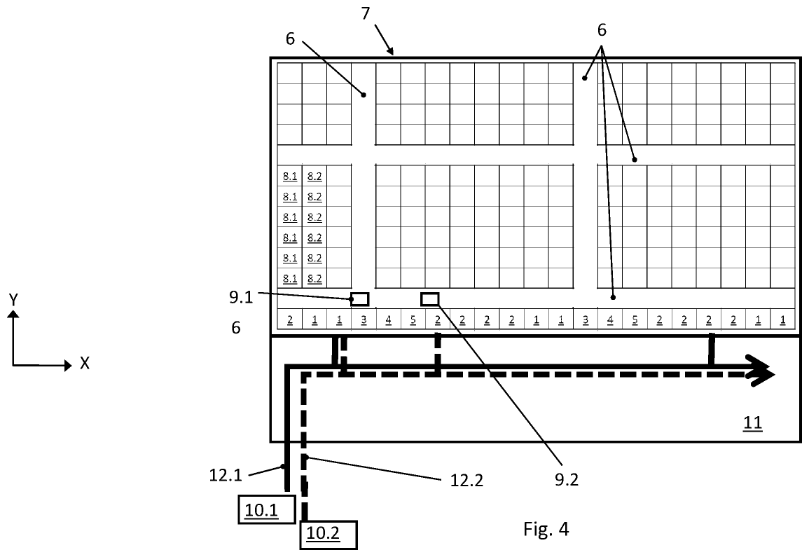

In FIGS. 3 and 4, two shuttles 9.1, 9.2 and two AGVs 10.1, 10.2 are indicated.

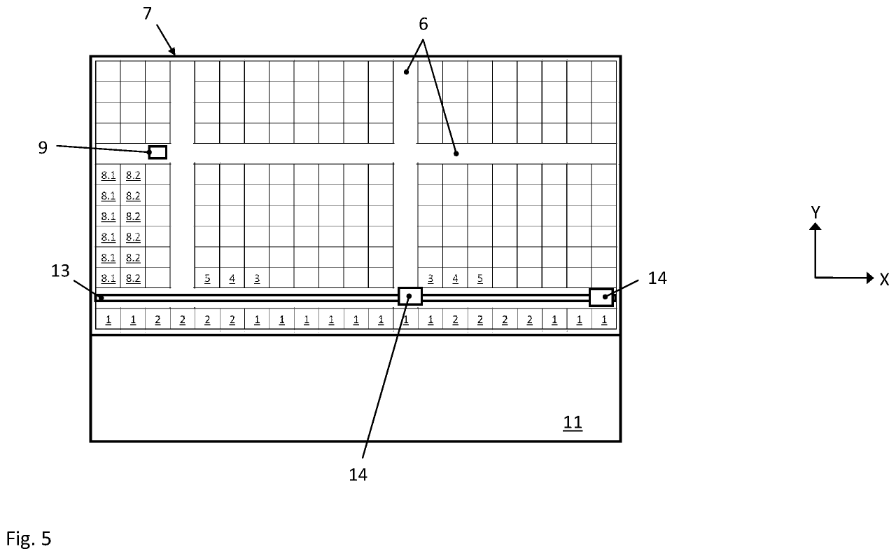

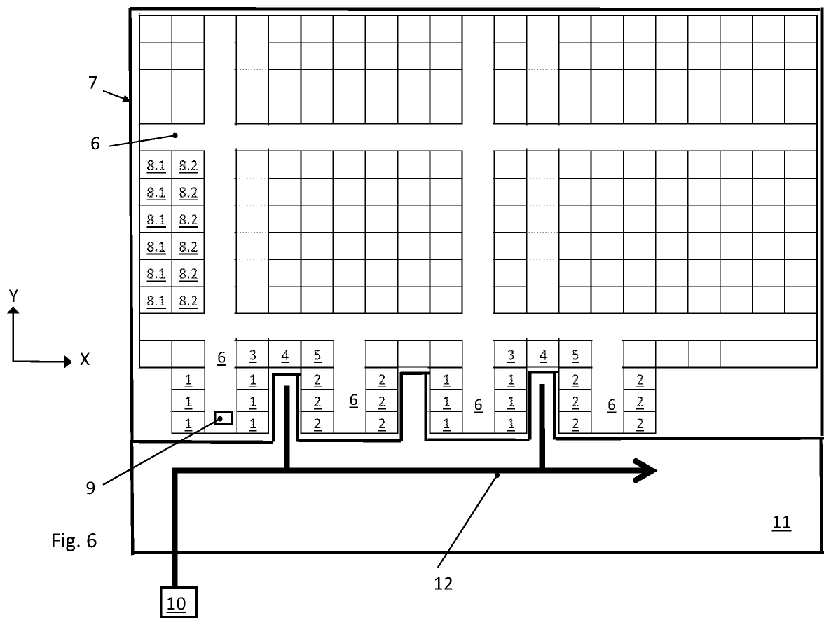

Two AGV travel directions (“travel directions” for short) 12.1, 12.2 are visible in FIGS. 1 to 4. In particular in FIGS. 3 and 4, the travel directions 12.1, 12.2 represent the travel paths of the AGV 10.1, 10.2 in the storage pre-zone 11. In FIG. 5, for the sake of improved clarity no travel direction 12 is indicated, and in FIG. 6, for the sake of improved clarity, just one single travel direction 12 is indicated.

In contrast to those according to FIGS. 1 to 4, the embodiment according to FIG. 5 comprises transverse travel trolleys 14 on a rail 13.

In contrast to those according to FIGS. 1 to 5, the embodiment according to FIG. 6 comprises arrangements of the transfer stations 1, 2 which are sawtooth-like and which protrude into the storage pre-zone 11 in the y-direction.

For the sake of improved clarity, identical elements are not provided with reference signs in all of the figures.

With reference to FIGS. 1 to 6, the mode of operation of the shuttle system according to the invention can be explained as follows:

As is visible for example in FIG. 4, an AGV 10.1, laden with a load carrier (not shown here), for example a pallet, travels into the storage pre-zone 11. The AGV 10.1 can for example firstly deposit a pallet on a first transfer station 1, following the travel direction 12.1. This is indicated in FIG. 4 by a perpendicular, continuous line, but which is not provided with an arrowhead, which extends as a branch of the travel direction 12.1 to the first transfer station 1, which is arranged as the third transfer station 1 from the left in FIG. 4.

In an analogous manner, the AGV 10.1 in FIG. 3, which follows the travel direction 12.1, deposits its pallet on the first transfer station 1, which is arranged as the eighth transfer station 1 from the right. This is also indicated in FIG. 3 by a perpendicular line branching off from the travel direction 12.1.

Subsequently, in the example according to FIG. 4 the AGV 10.1 travels along a shelf front in the arrow direction, i.e. to the right in FIG. 4. This corresponds to “downstream” travel with respect to the travel directions 12.1, 12.2.

In its outline, the shelf front, not provided with reference signs here, denotes, in outline, an edge of the shelf construction, i.e. here the storage and retrieval plane 7 which adjoins the storage pre-zone 11.

After the AGV 10.1, now no longer laden, has travelled a little way in the direction of the arrow representing the travel direction 12.1, i.e. to the right in FIGS. 3 and 4, it receives a pallet (not shown) from a second transfer station 2. In FIGS. 3 and 4 this is the second transfer station 2, which is arranged as the third transfer station 2 from the right. Thereafter, the AGV 10.1 leaves the storage pre-zone 11 in the direction of the arrow representing the travel direction 12.1, i.e. to the right in FIGS. 3 and 4, which is merely indicated by the arrowhead here.

In the variant according to FIG. 4, the first shuttle 9.1 transports the pallet, deposited by the AGV 10.1 on the first transfer station 1, to the transfer location 3. Thus, a second AGV 10.2, which enters the storage pre-zone 11 after the AGV 10.1 described above, can deposit a pallet on the same first transfer station 1. The travel direction 12.2 of the second AGV 10.2 is indicated by a dashed line.

After the first shuttle 9.1 has transported the pallet, deposited by the first-mentioned AGV 10.1 on the first transfer station 1, to the directly adjacent first transfer location 3, the vertical conveyor 4 located directly adjacently i.e. the vertical conveyor 4 shown on the left in FIG. 4, and the vertical conveyor 4 shown on the right in FIG. 3, conveys the pallet into a storage plane (not shown). On the return journey into the storage and retrieval plane 7, the vertical conveyor 4 conveys a pallet to be removed from storage, which it deposits directly beside it on the second transfer location 5. The second shuttle 9.2 transports the pallet, to be removed from storage, from said second transfer location 5 to a second transfer station 2 assigned to the vertical conveyor 4, i.e., in FIG. 4, to the second transfer station 2 directly adjoining the second transfer location 5. From there, the second AGV 10.2 collects said pallet and subsequently travels along the shelf front, in the travel direction 12.2, to its target location. The collection of the pallet by the second AGV 10.2 is indicated by a dashed line that extends vertically, i.e. in the y-direction, which line branches off from the second travel direction 12.2.

In the case of the mode of operation described above, the vertical conveyors 4 perform double runs, i.e. are operated efficiently. The AGVs 10.1, 10.2 do not have to wait at the transfer stations 1, 2. Furthermore, there is no oncoming traffic involving two AGVs 10.1, 10.2, because these travel in the same direction 12.1, 12.2 along the shelf front, and in each case firstly deposit a pallet on one of the first transfer stations 1, and subsequently receive a pallet from one of the downstream second transfer stations 2. In this case, the statement regarding “the same direction” of the AGVs 10.1, 10.2 refers to the direction extending along the x-direction. Short portions in the y-direction, in order to receive or deposit a pallet, are not meant by this. Furthermore, the entries of the AGV into the bays extending in the y-direction, which bays are formed between the transfer stations 1, 2, are likewise not meant.

In the embodiment shown in FIG. 5, the shuttles 9.1, 9.2, which oscillate between the transfer locations 3, 5 and transfer stations 1, 2, are replaced by the transverse travel trolley 14.

In the embodiment shown in FIG. 6, the storage and retrieval plane 7 and the storage pre-zone 11 mesh with one another. For depositing and receiving a pallet, the AGV 10 travels into the bays which are formed between the transfer stations 1, 2 and extend in the y-direction. In the variant according to FIG. 6, more transfer stations 1, 2 can be arranged along the shelf front, i.e. along the x-direction, than in the variants according to FIGS. 1 to 5.

FIGS. 1 to 6 each show different details of embodiments of the shuttle system according to the invention and of the method according to the invention, which was indicated above only in essential features. These details are explained in the following.

All the storage and retrieval planes 7, of which details are shown in FIGS. 1 to 6, are part of a shelf construction (not shown, in each case). Irrespective of the exact number and position of the individual storage locations 8.1, 8.2, 8.3, all shelf constructions can be described as being substantially rectangular in plan view or in outline. This explicitly also applies for the arrangement according to FIGS. 2 and 6, which entirely deviate from an ideal rectangle.

Nonetheless, the illustration according to FIG. 2 also shows a substantially rectangular storage and retrieval plane: Firstly, the storage locations 8.1, 8.2, 8.3, arranged in a grid-like manner, and the travel paths 6 located therebetween, allow for the same shuttle journeys as the storage and retrieval planes of FIGS. 1, 3 and 4. Furthermore, the shelf front (not provided with reference signs) allows the AGV 10 to travel along at the boundary to the storage pre-zone 11. Thus, in particular regarding the mode of operation of the shuttle system, the deviations from an ideal rectangle, shown in FIG. 2, are not serious.

Similar applies for the variant according to FIG. 6: For the storage locations 8.1, 8.2 and the travel paths 6 etc. the same applies as for FIG. 2. Furthermore, the structure at the boundary between the storage pre-zone 11 and the storage and retrieval plane 7 resembles the eversions and inversions of biological membranes, which ultimately lead to an increase in surface area. In the variant according to FIG. 6, this arrangement means that more transfer stations 1, 2 are arranged along the shelf front extending in the x-direction than would be the case without the sawtooth-like structure according to FIG. 6.

As already mentioned, FIGS. 1 to 6 show only a detail of a shelf construction outline. A shelf construction can comprise significantly more than two vertical conveyors 4 and correspondingly more storage locations 8, travel paths 6, etc. However, the mode of operation can be explained well on the basis of the details shown.

In each case two possible travel directions 12.1, 12.2 are indicated in FIGS. 1 to 4. In FIGS. 3 and 4, the corresponding arrows for the travel directions 12.1, 12.1 show the overall travel profiles of the AGV 10, including the approaches of the transfer stations 1, 2. These departures and approaches from and to the transfer stations 1, 2, extending in the y-direction in the figures, are not shown in FIGS. 1 and 2.

No travel direction or just one travel direction 12 is shown in FIGS. 5 and 6.

In this case, the travel directions 12, 12.1, 12.2 show travel paths of the AGVs 10, 10.1, 10.2 to individual transfer stations 1, 2 merely by way of example. Other transfer stations 1, 2 could also be approached in each case, provided that initially a first transfer station 1 and thereafter a downstream second transfer station 2 are approached.

As shown in FIGS. 1 to 4, the AGVs 10.1, 10.2 preferably enter the storage pre-zone 11 at the same point. At this point, a contour control means (not shown) can be installed, which ensures that the AGV 10.1, 10.2 can deposit its pallet on a first transfer station 1 in an error-free manner, and that said pallet can subsequently be put into storage in an error-free manner

As shown in FIGS. 1, 3, 4 and 6, it can be possible for the AGV 10, 10.1, 10.2 to directly approach the shelf front after entering the storage pre-zone 11, and to subsequently continue its travel along the shelf front, i.e. in the x-direction. Alternatively, it may for example be conceivable for the AGV 10, 10.1, 10.2 to approach the shelf front at the point at which the first transfer station 1 is located, on which transfer station the relevant AGV 10.1, 10.2 is intended to deposit the loaded pallet. In FIG. 2, the AGV 10.1 (not shown in FIG. 2), which follows the travel direction 12.1, can deposit a pallet from the left on the “third” first transfer station 1. The AGV 10.2 (likewise not shown), which follows the travel direction 12.2, could deposit a pallet on the “seventh” first transfer station 1 from the right. If the travel directions 12.1, 12.2 of FIGS. 1 and 2 are compared, then in FIG. 1 a single-lane one-way path, and in FIG. 2 a two-lane one-way path, is provided. An advantage of the variants according to FIG. 2 can be that the AGVs 10.1, 10.2 do not block one another even if they approach at short distances after one another, and the front AGV 10.1 stops in front of a transfer station 1, 2. An advantage of the arrangement according to FIG. 1 can be that the storage pre-zone 11 requires very little space, i.e. its extension in the y-direction could be made significantly smaller.

While it is intended, according to FIGS. 1, 2, and 4, for the AGVs 10.1, 10.2 to approach the shelf front in each case from the edge, from the left in the above figures, the point or portion at which the AGVs 10.1, 10.2 in FIG. 3 approach the shelf front is arranged more centrally.

In all the embodiments, AGVs 10.1, 10.2 entering the storage pre-zone 11 one behind the other can follow either the travel direction 12.1 or the travel direction 12.2. In this case, a situation with oncoming traffic does not occur in any of the cases, i.e. it is not possible, at any point or portion along the shelf front, for two AGVs 10.1, 10.2 to meet one another. The travel direction, either to the left or to the right, is always fixed, as soon as the AGV 10.1, 10.2 moves along the shelf front, i.e. in the x-direction.

Preferably, the transfer locations 3, 5 are accessible for the shuttles 9.1, 9.2 only from the storage side, while the transfer stations 1, 2 are accessible both for the shuttles 9.1, 9.2 and for the AGVs 10, 10.1, 10.2. Pallets which were delivered from the AGV 10, 10.1, 10.2 can be temporarily stored on the first transfer stations 1, until the first transfer location 3 of the vertical conveyor 5 is free and a shuttle 9, 9.1, 9.2 can transport the pallet from the first transfer station 1 to the first transfer location 3. Vice versa, pallets which cannot be received directly from an AGV 10.1, 10.2 can be temporarily stored on one of the second transfer stations 2, in order not to block the second transfer location 5. The selected arrangement having exactly two transfer locations 3, 5 to the side of the vertical conveyors 4 in each case, and at least two first and at least two second transfer stations 1, 2 in each case, thus ensures that the vertical conveyor 4 can be operated as efficiently as possible, independently of the AGVs 10, 10.1, 10.2, and in this case as far as possible performs double runs.

Preferably, the first and second transfer stations 1, 2 are identical in design. Therefore, if required, it is possible to identify, depending on an assignment load, whether each vertical conveyor 4 is assigned the same number of first and second transfer stations 1, 2, or whether for example more second transfer stations 2 are present, because a very large number of pallets are intended to be removed from storage in a certain time period. The last-mentioned case is shown in FIG. 4 where, in contrast to FIGS. 1 to 3, more second transfer stations 2 are present. Adjacent vertical conveyors 4, which are assigned a specific number of transfer stations 1, 2 in each case, can thus also share one or more transfer stations 1, 2. However, the shuttle system can be operated in such a way that each vertical conveyor 4 in the shelf is assigned at least one first transfer station 1 and one second transfer station 2 at every timepoint.

It can be possible to place the vertical conveyors 4 and the associated transfer locations 3, 5 directly on the shelf front, on the storage side, as is shown in FIGS. 1, 2 and 4. Alternatively, it can also be possible to shift the vertical conveyors 4 and the associated transfer locations 3, 5 a little in the y-direction, such that they no longer directly adjoin the shelf front. As shown in FIG. 3, in the last-mentioned case all the locations along the shelf front can be configured as transfer stations 1, 2. In the case of the arrangement shown in FIG. 3, it is advantageous that more transfer stations 1, 2 are available, which can increase the flexibility and the throughput. An advantage of the arrangement according to FIGS. 1, 2 and 4 having a vertical conveyor located directly at the shelf front is that of easy access to the vertical conveyor 4 for servicing and repair work.

If the shuttles 9.1, 9.2 are responsible for the transfer of the load carriers between the transfer stations 1, 2 and the transfer locations 3, 5, then, in the embodiments according to FIGS. 1 to 6, said shuttles 9.1, 9.2 have to perform at most two direction changes, while they convey a load carrier from a transfer station 1, 2 to a transfer location 3, 5 or vice versa. In this case a direction change means that the travel occurs initially in parallel with the x-direction and subsequently in parallel with the y-direction, or vice versa, wherein it is irrelevant whether the travel takes place in the positive or negative x-direction (to the right or left in the figures). In this case, it should also be considered whether the shuttles 9, 9.1, 9.2 enter the transfer locations 3, 5 and the transfer stations 1, 2, which is generally the case. What is essential for the existence of a change in direction is whether a change in direction takes place from the horizontal (with respect to the figures), i.e. in parallel with the x-direction, to the vertical, i.e. in parallel with the y-direction, or vice versa.

In FIGS. 1, 2 and 4, in the case of transfer of a load carrier between the transfer stations 1, 2 and the transfer locations 3, 5 the shuttles 9.1, 9.2 perform two such direction changes, in the variant according to FIG. 3 there may also be cases, depending on the transfer stations 1, 2 to be approached, in which no direction change is required. In the variant according to FIG. 3 also, two direction changes may be required, depending on the transfer station 1, 2 to be approached.

In the embodiment according to FIG. 5, the transverse travel trolleys 14 accept the transfer of the load carriers between the transfer stations 1, 2 and the transfer locations 3, 5. The transverse travel trolleys 14 can thus replace the shuttles 9.1, 9.2 described above. Nonetheless, in the variant according to FIG. 5 at least one shuttle 9 is also present within the storage and retrieval plane 7, in order to serve the storage locations 8.1, 8.2 there. A shuttle of this kind can collect a load carrier, to be put into storage in the storage and retrieval plane 7, from a first transfer station 1 or accept it from the transverse travel trolley 14 which has in turn previously collected the load carrier from a first transfer station 1.

The transverse travel trolleys 14 are movable on the rail 13 in parallel with the shelf front, i.e. along the x-direction. They preferably comprise a telescopic fork (not shown), which is extendable transversely to the shelf front, i.e. in the y-direction. Alternatively or additionally, the transverse travel trolleys 14 can comprise a chain conveyor or the like. By means of the telescopic fork, the transverse travel trolleys 14 can receive a load carrier, to be put into storage, from a first transfer station 1, and transfer it to a vertical conveyor 4 or to a shuttle 9. Vice versa, the transverse travel trolleys 14 can accept a load carrier, to be taken out of storage, from the vertical conveyor 4 or a shuttle 9 and deposit it on a second transfer station 2, using the telescopic fork.

Although just some preferred embodiments of the invention have been described and illustrated, it is clear that a person skilled in the art can add numerous modifications, without departing from the essence and scope of the invention. Without limitation, the following modifications may be possible:

The vertical conveyors 4 shown are arranged directly on the shelf front or at least close to the shelf front and are served by at least one or more shuttles 9.1, 9.2 which deposits pallets on the first transfer location 3 or receives them from the second transfer location 5. The shuttle system can comprise further vertical conveyors, for example for the shuttles 9, which are not assigned any transfer stations 1, 2. Preferably, however, the vertical conveyors 4 which are arranged directly at or at least close to the shelf front are each assigned a plurality of transfer stations 1, 2.

Embodiments may also be conceivable, for example, in which, in the shelf construction, further vertical conveyors for the pallets are provided opposite the shelf front equipped with transfer stations 1, 2, which vertical conveyors allow, for example, a transfer of pallets between the planes of the shelf construction. Such vertical conveyors do not have to be assigned any transfer stations 1, 2.

As can be seen from a comparison of FIG. 3 with FIGS. 1, 2 and 4, the first transfer stations 1 and the first transfer locations 3 in the travel direction 12.1, 12.2 are then also arranged in front of the respective vertical conveyor 4, when this is arranged further towards the inside in the shelf construction. The same applies for the second transfer stations 2 and second transfer locations 5, which are arranged after the respective vertical conveyor 4 in the travel direction 12.1, 12.2.

This applies although in each case a second transfer station 2 is arranged at the height of the vertical conveyor 4, in the x-direction. With respect to the transfer stations 1, 2, the statement above thus applies for all, or for all bar one, transfer station 1, 2 per vertical conveyor 4.

The pallets to be put into storage are thus always deposited, with respect to the travel direction 12.1, 12.2, in front of the respective vertical conveyor 4, by means of which said pallet is intended to be transported into a storage plane, irrespective of whether the vertical conveyor 4 is arranged directly on the shelf front. Correspondingly, a pallet conveyed by the vertical conveyor 4 from a storage plane into the storage and retrieval plane 7 is deposited on one of the second transfer stations 2 which is located after the vertical conveyor 4 in the x-direction, i.e. downstream.

Similar considerations can apply for the variant according to FIG. 6.

The travel directions 12, 12.1, 12.2 show travel paths of AGVs 10, 10.1, 10.2 merely by way of example.

AGVs 10.1, 10.2 can deviate from these examples insofar as the storing and retrieving, indicated by vertical lines in FIGS. 3, 4 and 6, can take place at any transfer stations 1, 2 along the shelf front, wherein, however, preferably firstly the transfer of a load carrier to a first transfer station 1 takes place, and subsequently the receiving of a load carrier from a second transfer station 2 takes place. The second transfer station 2 is thus located downstream of the first transfer station 1 in the travel direction 12.1, 12.2. As long as the above-mentioned requirement is met, deviations from the shown travel directions 12, 12.1, 12.2 are conceivable. In all cases, however, the AGVs 10, 10.1, 10.2 preferably travel in parallel with the shelf front, i.e. in the figures to the left or right in the x-direction, over large portions. Travel along the y-direction preferably takes place only in order to change lane in a “multi-lane” storage pre-zone 11, and for accepting and transferring a load carrier. In the variant according to FIG. 6, the AGV 10 travels in the y-direction in an inversion extending in a bay-like or blind hole-like manner, which is formed by the arrangement of the transfer stations 1, 2.

In rare cases, diagonal travel of the AGVs 10.1, 10.2 is also conceivable, which travel does not extend in parallel either with the y-direction or with the x-direction.

In each case six transfer stations 1, 2 are assigned to the vertical conveyors 4 in FIGS. 1, 2 and 4. While in each case three first and three second transfer stations 1, 2 are assigned to the vertical conveyors 4 in FIGS. 1 and 2, the vertical conveyor 4 in FIG. 4 is assigned two first and four second transfer stations 1, 2. It can be conceivable to assign the vertical conveyors 4 more or fewer transfer stations 1, 2. If just two transfer stations 1, 2 are assigned to each vertical conveyor 4, then the first transfer stations 1 is typically operated, at each timepoint, as the first transfer station 1, and thus for accepting a pallet. Corresponding applies for the second transfer station 2. However, if each vertical conveyor 4 is assigned at least three transfer stations 1, 2, then it is possible to determine, for at least one of the three transfer stations 1, 2, depending on an assignment load, whether said station is operated as a first transfer station 1 and is thus responsible for storing a pallet in the shelf construction, or whether it is operated as a second transfer station 2, and is thus responsible for retrieving a pallet from storage, out of the shelf construction.

If each vertical conveyor 4 is assigned at least three transfer stations 1, 2, then a dynamic allocation of the mode of operation of the transfer stations 1, 2 as first or second transfer stations 1, 2 is thus possible.

Instead of the pallets, any other load carriers can also be handled.

Instead of the AGVs 10.1, 10.2, other industrial trucks are also conceivable.

The shelf front can be configured differently from what is shown in FIGS. 1 to 6. However, the AGVs 10, 10.1, 10.2 preferably travel substantially in parallel with and preferably also along the shelf front, i.e. in the figures substantially along the x-direction, and in this case preferably close to the shelf front. Further preferably, the AGVs 10.1, 10.2 furthermore always initially deposit a pallet on a first transfer station 1, from which said pallet is transported by a shuttle 9, preferably by a first shuttle 9.1, to a first transfer location 3 located at the same height or downstream in the travel direction 12, 12.1, 12.2. Subsequently, the AGV 10, 10.1, 10.2 receives a pallet from a second transfer station 2 located downstream of the first transfer station 1, wherein said pallet was previously received by the shuttle 9, preferably by the second shuttle 9.2, to a second transfer location 5 of a vertical conveyor 4 located at the same height as or upstream of the second transfer station 2, and transported to the second transfer station 2. In all conceivable variants, it is envisaged that the shelf front and the travel direction 12.1, 12.1 preferably extending substantially in parallel with the shelf front the measure for the assignment of the “first” and “second” transfer stations 1, 2 “before” and “after” the respective vertical conveyors 4.

The shuttles 9, 9.1, 9.2 are preferably configured as bidirectional shuttles 9, which can travel on the travel paths 6 in the x- and y-direction, and can change their travel direction about 90° at junctions of the travel paths 6. Alternative shuttles are conceivable.

As is clear from FIGS. 1, 3 and 4, substantially single-lane one-way operation can prevail in the storage pre-zone 11, in which travel directions 12.1, 12.2 of the AGV substantially coincide, as is shown in FIGS. 1 and 4. Alternatively, the travel directions 12.1, 12.2 of the AGVs 10.1, 10.2 can be located at least at the same height in the y-direction, as can be seen in FIG. 3. Alternatively again, multi-lane one-way operation can prevail, in which two or more AGVs 10.1, 10.2 can move substantially in parallel with one another and in parallel with the shelf front, in the travel direction 12.1, 12.2, which follows to some extent from FIG. 2.

All the features and details shown in one of FIGS. 1 to 4 and 6 can be combined with the remaining features and details of the other figures in each case.

After leaving the storage pre-zone 11, i.e. to the right in FIGS. 1 to 4 and 6, and, alternatively, to the left in FIG. 3, a target location can follow, at which the AGVs 10.1, 10.2 deposit the pallet received at the second transfer station 2. This can for example be an order picking station, a lorry cargo area, a production facility, or the like.

As shown in FIG. 3, the shelf front can be divided into portions, wherein the AGVs 10.1, 10.2 travel in the same direction in each portion along the shelf front, i.e. in the x-direction, wherein, however, the travel direction of the AGVs 10.1, 10.2 differs between the respective portions. In the left-hand portion of FIG. 3, the AGVs 10.1, 10.2 travel to the left, and in the right-hand portion to the right. In order not to create any oncoming traffic, preferably at most two such portions are provided. If a plurality of portions is provided, then oncoming traffic would have to be accepted, or be prevented in that not all AGVs 10.1, 10.2 travel along directly at the shelf front, but rather travel for example in a manner offset in the y-direction, i.e. offset “downwards” in the figures.

It can also be provided that certain pallets are not put into storage or removed from storage in or from one of the storage planes (not shown), but rather directly in the storage and retrieval plane 7. Storing in the storage and retrieval plane takes place for example in that an AGV 10, 10.1, 10.2 deposits a pallet on a first transfer station 1, and this is subsequently transported by a shuttle 9 to a storage location in the storage and retrieval plane 7. Retrieving takes place in that a shuttle 9 receives a pallet form a storage location in the storage and retrieval plane 7 and transports it to a second transfer station 2 and deposits it there. The shuttle 9, which performs the above-mentioned actions, is preferably not the first and second shuttle 9.1, 9.2, since these are specifically and preferably exclusively responsible for the transport of pallets from the transfer stations 1, 2 to the transfer locations 3, 5 of the vertical conveyor 4.

It may be the case that an AGV 10, 10.1, 10.2 travels empty, i.e. not laden with a pallet, into the storage pre-zone 11, or in general approaches the shelf front. In such a case, the AGV 10.1, 10.2 serves exclusively for removing a pallet from storage, which pallet said AGV collects from a second transfer station 2 and transports to a target location.

In the case of transfer of the load carriers between the transfer stations 1, 2 and the transfer locations 3, 5, preferably at most two direction changes occur in all the embodiments.

For structural reasons, for example, it may be the case that at least one of the vertical conveyors 4 is assigned fewer transfer stations 1, 2.

The transverse travel trolleys 14 can, instead of a telescopic fork, also comprise another load handling device.

Although this is not shown in FIGS. 5 and 6, in this case, similarly to the variants according to FIGS. 1 to 4, a plurality of AGVs 10.1, 10.2 can also travel along corresponding travel directions 12.1, 12.2. It is the case for all the figures that a plurality of AGVs 10, 10.1, 10.2, i.e. in particular more than two, can always travel along the shelf front.

In all embodiments, a position, an arrangement and a number of any travel paths 6 can be changed. In this case it should be noted that unladen shuttles 9, 9.1, 9.2 can generally also use storage locations 8, 8.1, 8.2, 8.3 and the storage channels formed thereby as travel paths. This is generally the case for laden shuttles at least when the corresponding storage locations are not occupied by a load carrier.

Depending on the configuration of the shelf construction, in the variant according to FIG. 6 it may be conceivable that a AGV 10 travelling into the bay-like recesses may rotate about 90° before entering. This may be necessary in order that the AGV is subsequently oriented in such a way that a transfer of the load carrier to the first transfer station 1 is possible.

It is the case for all variants that the load carriers (not shown) are preferably configured so as to be rectangular or square. In the case of rectangular load carriers, there may be various arrangements with respect to the x- and y-direction, depending on all the components of the shuttle system, i.e. on the transfer locations 3, 5 and transfer stations 1, 2, on the shuttles 9, 9.1, 9.2, and on the AGVs 10, 10.1, 10.2, and on the travel and deposition rails. This may be relevant for the question of whether a transfer of a load carrier from one of the components of the shuttle system to another component takes place in the x- or y-direction. In this case, all the embodiments are intended to also have an arrangement of the above-mentioned components that is rotated about 90° with respect to the x- and y-directions.

Despite the sawtooth-like configuration, the transfer stations 1, 2 in FIG. 6 are arranged “along” the longitudinal direction of the shelf front, i.e. “along” the x-direction.

It may also be conceivable to determine, if necessary depending on the assignment load, whether the transfer locations 3, 5 are used for storing or retrieving. This has already been described in relation to the transfer stations 1, 2. The determination, dependent on the assignment load, as to whether the transfer locations 3, 5 are used as the first transfer location 3 or second transfer location 5 can take place alternatively or in addition to the corresponding assignment load-dependent determination of the transfer stations 1, 2.

1. A shuttle system comprising:
a shelf construction having a storage and retrieval plane; and
at least one storage plane;
wherein the shuttle system comprises at least one shuttle that moves in planes of the shelf construction; the shelf construction comprises a shelf front; the shelf construction comprises at least one vertical conveyor; the shelf construction comprises at least two transfer stations, along the shelf front, for storing a load carrier into storage and retrieving it from storage into/from the shelf construction; at least two transfer stations are assigned to the vertical conveyor; the transfer stations are configured to allow a transfer of a load carrier from a shuttle travelling in the storage and retrieval plane or from a transverse travel trolley travelling in parallel with the shelf front in the storage and retrieval plane to an industrial truck travelling along the shelf front, and vice versa; at least two transfer locations are assigned to the at least one vertical conveyor; and the transfer locations are configured to allow a transfer of a load carrier from the vertical conveyor to a shuttle travelling in the storage and retrieval plane, and vice versa, or to the transverse travel trolley, and vice versa.

2. The shuttle system according to claim 1, wherein at least two transfer stations are assigned to the at least one vertical conveyor such that in each case at least one transfer station is located before and after the vertical conveyor, along the shelf front, and/or wherein at least two transfer locations are assigned to the at least one vertical conveyor such that in each case at least one transfer location is located before and after the vertical conveyor, along the shelf front.

3. The shuttle system according to claim 1, wherein at least one shuttle is assigned to each vertical conveyor, which shuttle is configured to transport load carriers from the transfer stations to the transfer locations and back.

4. A method for operating a shuttle system according to claim 1, wherein the at least one shuttle or a transverse travel trolley accepts a load carrier to be put into storage from a transfer station and/or transfers a load carrier to be removed from storage to a transfer station.

5. The method according to claim 4, wherein the method comprises storing and/or retrieving at least one load carrier from a storage plane or into a storage plane, wherein:
for storing a load carrier in a storage plane, the load carrier is deposited on a first transfer station and subsequently transported by a shuttle or a transverse travel trolley to a first transfer location assigned to the vertical conveyor, whereupon the vertical conveyor accepts the load carrier and conveys it into the storage plane; and
for retrieving a load carrier stored in a storage plane, the load carrier is transferred from a shuttle travelling in the storage plane to the vertical conveyor, whereupon the vertical conveyor conveys the load carrier into the storage and retrieval plane and deposits it on a second transfer location, where a shuttle or a transverse travel trolley accepts the load carrier and transports it to a second transfer station.

6. The method according to claim 4, wherein the method comprises a storing and/or a retrieving of at least one load carrier from or into a storage and retrieval plane, wherein:
for storing a load carrier in the storage and retrieval plane, the load carrier is deposited on a first transfer station and subsequently transported by a shuttle to a storage location; and
for retrieving a load carrier that is stored in the storage and retrieval plane, said load carrier is accepted, at its storage location, by a shuttle and transported to a second transfer station.

7. The method according to claim 5, wherein the method comprises a storing and/or a retrieving of at least one load carrier from or into a storage and retrieval plane, wherein:
for storing a load carrier in the storage and retrieval plane, the load carrier is deposited on a first transfer station and subsequently transported by a shuttle to a storage location; and
for retrieving a load carrier that is stored in the storage and retrieval plane, said load carrier is accepted, at its storage location, by a shuttle and transported to a second transfer station.

8. The method according claim 4, wherein the method comprises storing and/or a retrieving of at least one load carrier from or into the storage and retrieval plane, wherein:
for storing a load carrier in the storage and retrieval plane, the load carrier is deposited on a first transfer station and subsequently received by a transverse travel trolley and transferred to a shuttle, which transports the load carrier to a storage location; and
for retrieving a load carrier that is stored in the storage and retrieval plane, said load carrier is accepted, at its storage location, by a shuttle and transferred to the transverse travel trolley, which transports the load carrier to a second transfer station.

9. The method according claim 5, wherein the method comprises storing and/or a retrieving of at least one load carrier from or into the storage and retrieval plane, wherein:
for storing a load carrier in the storage and retrieval plane, the load carrier is deposited on a first transfer station and subsequently received by a transverse travel trolley and transferred to a shuttle, which transports the load carrier to a storage location; and
for retrieving a load carrier that is stored in the storage and retrieval plane, said load carrier is accepted, at its storage location, by a shuttle and transferred to the transverse travel trolley, which transports the load carrier to the second transfer station.

10. The method according to claim 5, wherein the method comprises storing and/or a retrieving of load carriers into a storage plane and from a storage plane, wherein:
for storing the load carrier in the storage plane, the load carrier is deposited by an industrial truck onto the first transfer station, and subsequently transported by a first shuttle to a first transfer location of the vertical conveyor, whereupon the vertical conveyor accepts the load carrier and conveys it into the storage plane; and
for retrieving the load carrier stored in the storage plane, said load carrier is transferred from the shuttle travelling in the storage plane to the vertical conveyor, whereupon the vertical conveyor conveys the load carrier into the storage and retrieval plane and deposits it on the second transfer location, where Ss the load carrier and transports it to the second transfer station;
wherein the industrial truck or another industrial truck accepts the load carrier deposited on the second transfer station,
wherein a travel direction of the industrial truck extends along the shelf front, and
wherein, as the second transfer station, a transfer station is selected which is located downstream of the first transfer station with respect to the travel direction.

11. The method according to claim 4, including a preferred direction which prevails along the shelf front such that industrial trucks travelling along the shelf front move only in one direction, substantially at each point along the shelf front.

12. The method according to claim 4, wherein a central contour control takes place such that a plurality of industrial trucks passes the same device for contour control.

13. The method according to claim 4, wherein for operating a shuttle system, each vertical conveyor is assigned at least three transfer stations, and it is determined, for at least one of the transfer stations, depending on an assignment load, whether said transfer station is used for storing or for retrieving of load carriers.

14. The method according to claim 4, wherein a sequence formation for at least two load carriers to take place such that industrial trucks, which accept the load carriers from second transfer stations, form the sequence.

15. The method according to claim 5, in which a plurality of first and/or a plurality of second transfer stations are used, wherein the shuttle or the transverse travel trolley, for storing, transports to the vertical conveyor the load carrier, from a plurality of load carriers provided on a plurality of first transfer stations, which has a shortest travel path to the vertical conveyor, and/or that the shuttle or the transverse travel trolley, for retrieving, deposits a load carrier, to be removed from storage, on the second transfer station which has the shortest travel path to the vertical conveyor, of a group of a plurality of second transfer stations.

16. The method according to claim 4, wherein the shuttle system comprises a material flow calculator or is operatively connected to a material flow calculator.
